(19) United States
(12) Patent Application Publication
(10) Pub. No.: US 2013/0026309 A1
(43) Pub. Date: Jan. 31, 2013

(54) APPARATUS FOR SECURING A DEVICE IN A VIEWABLE LOCATION

(71) Applicants: Roger Ball, Little Rock, AR (US); Paul Freudenberg, Memphis, TN (US)

(72) Inventors: Roger Ball, Little Rock, AR (US); Paul Freudenberg, Memphis, TN (US)

(21) Appl. No.: 13/646,814

(22) Filed: Oct. 8, 2012

Related U.S. Application Data
(63) Continuation-in-part of application No. 13/294,489, filed on Nov. 11, 2011.
Application No. 13/294,489 is a continuation of application No. PCT/US2010/034565, filed on May 12, 2010.
(60) Provisional application No. 61/177,945, filed on May 13, 2009.

(51) Int. Cl. F16M 11/04; F16M 11/24

(52) U.S. Cl. 248/122.1; 248/125.8

(57) ABSTRACT

An apparatus for securing a device, such as a portable video player, in a viewable location. This and other objects of the invention are achieved by providing such an apparatus comprising a mast of selectable length, which has a clamp secured to an upper end of the mast in a selectable orientation. A pair of generally opposing jaws are carried by the clamp to engage at least two edges of the device, the jaws being coupled together for extension and retraction. A plurality of legs extend downwardly from a lower end of the mast, the legs being coupled to the mast for selective movement between a folded position and a deployed position. A flexible joint couples the clamp and mast to permit selective orientation of the clamp and device relative to the mast.

### CROSS REFERENCE TO RELATED APPLICATIONS

This application is a continuation-in-part of application Ser. No. 13/294,489 filed Nov. 11, 2011, which is a continuation of Application Serial Number PCT/US2010/034565, filed May 12, 2010, which claims priority to U.S. Provisional Application 61/177,945, filed May 13, 2009.

### FIELD OF THE INVENTION

The present invention relates to an apparatus for securing a device in a viewable location, which obviates the need to hold viewable devices in a viewer's hand.

### BACKGROUND

With the advent and popularity of portable video players (e.g. iPods® and similar players) and the increasing media capability of wireless phones or smartphones, there arises a need for an apparatus that can hold such a device for hands-free viewing of the device, such as when a user is traveling in an airplane. This invention addresses the problem of viewing a portable media device without requiring the device to be held in a viewer's hand. This invention thus allows viewing or listening to portable media while the viewer's hands are free.

### SUMMARY OF THE INVENTION

It is a general object of the present invention to provide an apparatus for securing a device, such as a portable video player, in a viewable location. This and other objects of the invention are achieved by providing such an apparatus comprising a mast of selectable length, which has a clamp secured to an upper end of the mast in a selectable orientation. A pair of generally opposing jaws are carried by the clamp to engage at least two edges of the device, the jaws being coupled together for extension and retraction. A plurality of legs extend downwardly from a lower end of the mast, the legs being coupled to the mast for selective movement between a folded position and a deployed position. A flexible joint couples the clamp and mast to permit selective orientation of the clamp and device relative to the mast.

According to a preferred embodiment of the invention, the legs further comprise three legs secured to the mast at their upper ends to form a collapsible tripod; and a locking ring slidably received over the mast and configured to releasably lock the legs in a deployed position.

According to a preferred embodiment of the invention, the jaws are coupled together by a rack and pinion arrangement, wherein movement of one jaw causes an equal and opposing movement by the other jaw.

According to a preferred embodiment of the invention, the mast further comprises a generally cylindrical upper mast section telescopically and slidingly received within a tubular lower mast section; and a lock ring carried between the upper and lower mast sections for selectively securing the upper and lower sections against relative movement.

According to a preferred embodiment of the invention, a portrait keyhole is formed in the clamp, the portrait keyhole cooperating with the flexible joint to maintain the clamp in a portrait orientation.

According to a preferred embodiment of the invention, a landscape keyhole formed in the clamp, the landscape keyhole cooperating with the flexible joint to maintain the clamp in a landscape orientation.

Other objects, features and advantages of the invention will become apparent with reference to the detailed description, which follows.

### BRIEF DESCRIPTION OF THE DRAWINGS

For a more complete understanding of the present invention, and the advantages thereof, reference is now made to the following descriptions taken in conjunction with the accompanying drawings, in which:

FIGS. 1-4 are elevation views of the apparatus or stand according to the present invention;

FIG. 5 is an enlarged side elevation view of the clamp assembly of the stand of FIGS. 1-4;

FIG. 6 is a plan view of the hinge member of the apparatus of FIGS. 1-4.

FIG. 7 is a perspective view of the apparatus according to another embodiment of the present invention.

FIG. 8 is an exploded view of the apparatus of FIG. 7.

FIG. 9 is a top elevation view of the clamp portion of the apparatus of FIGS. 7 and 8.

FIG. 10 is plan view, partially in section, of the apparatus shown in FIG. 9.

### DETAILED DESCRIPTION OF THE INVENTION

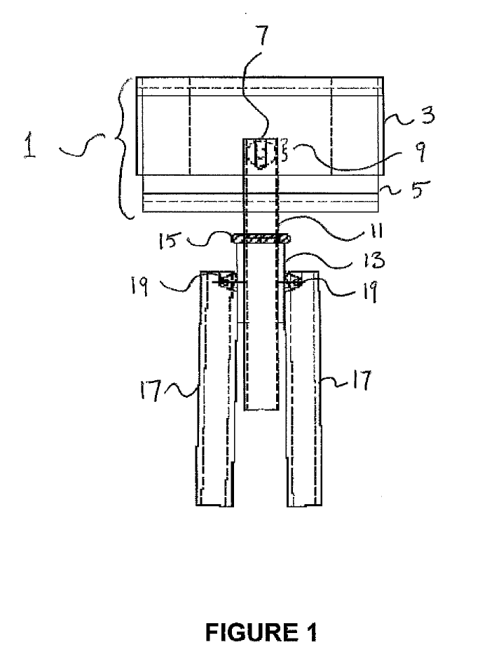

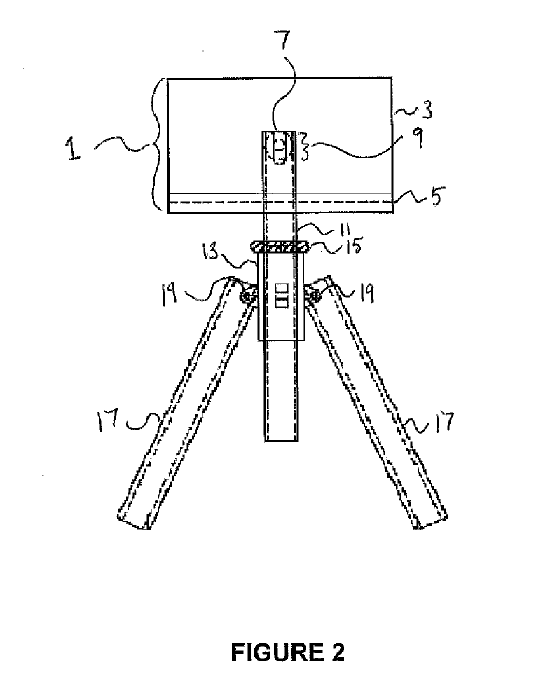

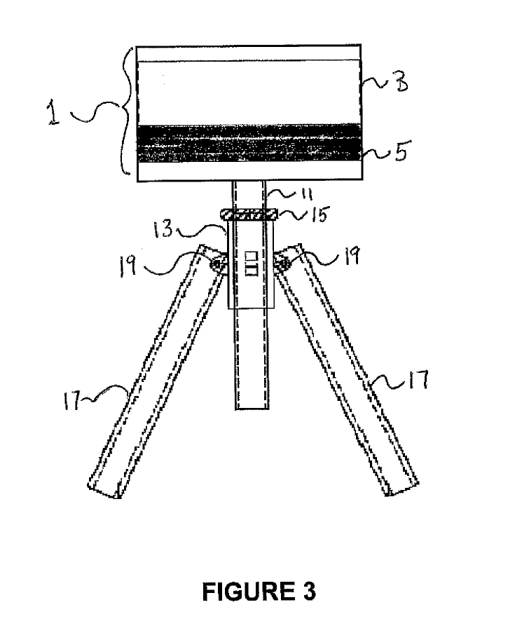

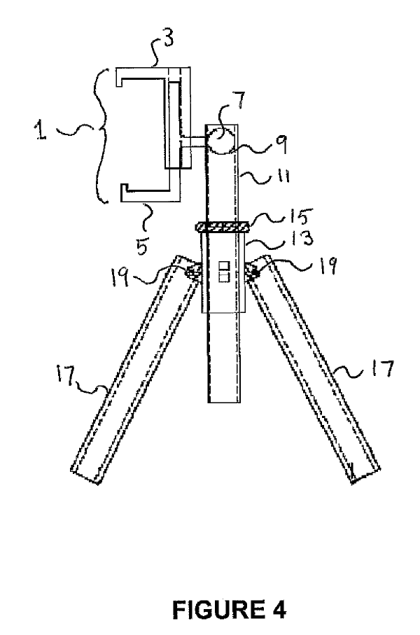

Referring now to the Figures, with particular reference to FIGS. 1-6, the apparatus according to the present invention is illustrated.

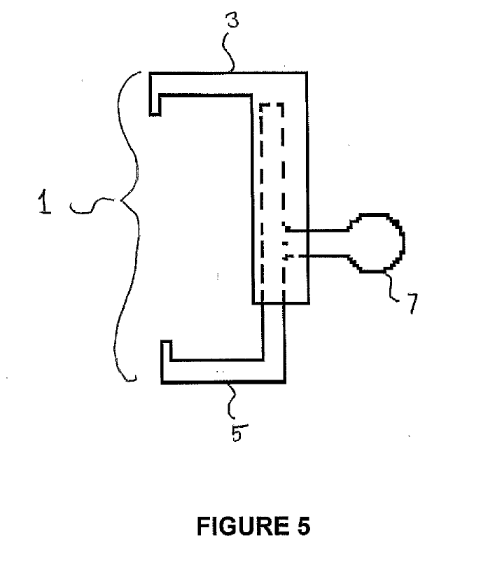

FIGS. 1-4 illustrate the clamp and stand of the apparatus of the present invention, which generally comprises a clamp for securing a portable media device to a stand for locating the device in a renewable location. Clamp 1 comprises an upper clamp portion 3 that is interference sliding fit to a lower clamp portion 5. The interference sliding fit allows the clamp width to be adjusted by a viewer to accommodate a variety of media devices (shown in phantom in FIG. 5) varying in size and shape.

A ball 7 is associated with the clamp and is received in a socket 9. The ball 7 and socket 9 connect clamp 1 to tubular elevation member 11 in a flexible joint or connection. Ball 7 is moveably interference fit in the upper end of tube 11, which defines socket 9. This allows for adjustment of clamp orientation with respect to the viewer.

Elevation member 11 is slidably received in a tubular hinge member 13. Movement of elevation member 11 relative to hinge member 13 is controlled by a resilient, elastomer o-ring 15 that encircles the elevation member 11 and provides a stop against further downward movement of elevation member 11 relative to hinge member 13. This arrangement allows the height of the clamp to be adjusted by the viewer for optimal viewing of a media device.

At least one and preferably three tubular legs 17 are secured in a tripod arrangement to hinge member 13 by three hinges spaced around the circumference of hinge member 13. Legs 17 thus are foldable or collapsible relative to the remainder of the stand or apparatus.

FIG. 5 illustrates the clamp in greater detail. Clamp 1 has an upper clamp portion 3, a lower clamp portion 5, and a ball 7 secured to one of portions 3, 5. Upper clamp portion 3 and lower clamp portion 5 fit into one another in a slidable interference fit configuration which allows for adjustment of the clamp for the accommodation of devices of varying size. The ball is sized for interference fit into a socket formed by elevation member 11 as described above. The sliding clamp portions can be adjusted to accept devices of varying shape and size. The orientation of the device may then be adjusted by the ball and socket connector to optimize viewing angle.

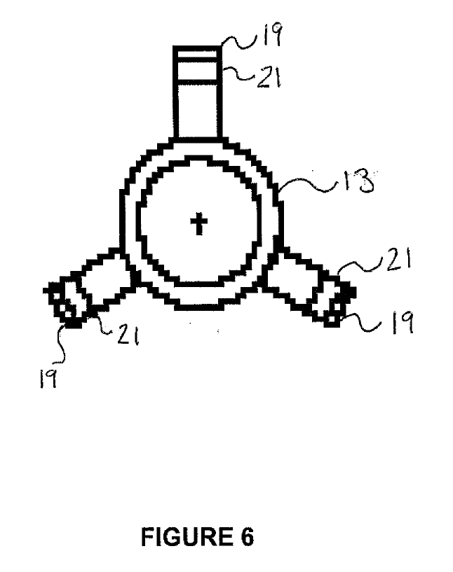

FIG. 6 illustrates the tubular hinge member 13 and hinges 19. As shown, the hinges 19 of the elevation member 13 are formed by hinge apertures 21. A pin 23 or other connecting piece extends through apertures in the upper portion of the legs 17 and the hinge aperture 21 to secure the legs to the hinge member 13. The three legs extend downward from the hinge member 13 and hinges 19 in a tripod arrangement such that the legs provide stable support for the apparatus upon a viewing surface when deployed. The legs may also be collapsed for storage of the apparatus.

As described above, the apparatus or stand according to the present invention can be stored with legs 17 collapsed in luggage or other relatively small spaces. The legs 17 can be deployed and placed on a surface, the portable device engaged in clamp 1, and the clamp oriented in a satisfactory manner for viewing. The relative height of clamp 1 can be adjusted by use of elevation member 11 and o-ring 15.

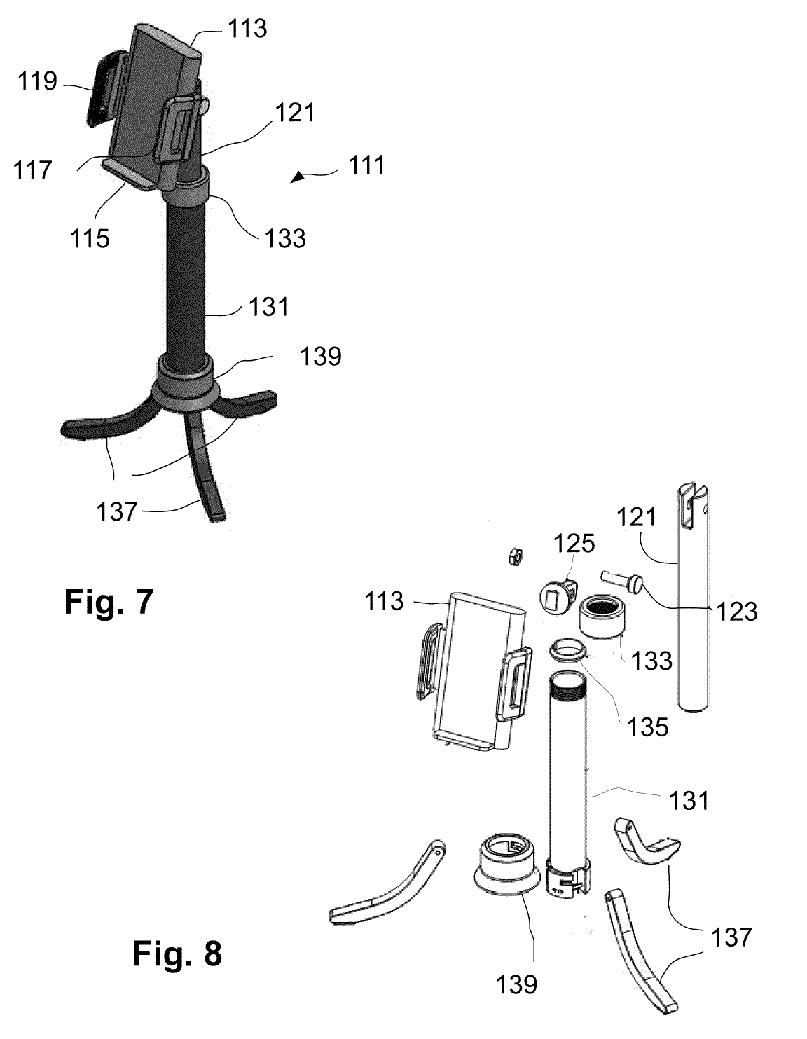

Referring now to FIGS. 7-10, the apparatus 111 according to another embodiment of the present invention is illustrated. As with the embodiment of FIGS. 1-6, apparatus 111 serves as a stand or holder for a portable device to secure it in a selected position.

Accordingly it is provided with a clamp assembly 113 at its upper end, which has a foot 115 (on which the portable device rests) and a pair of movable jaws 117, 119 to secure such a device. Clamp assembly 113 is mounted to the upper end of a generally cylindrical upper mast 121 by a thumbscrew 123, which cooperates with a connector 125 to define a hinge that permits clamp 113 to pivot relative to mast 121. Connector 125 is configured to releasably engage one of a pair of keyholes (127 in FIG. 10), that permit clamp assembly 113 to be oriented in either a “landscape” or “portrait” orientation. The portrait orientation is shown in FIGS. 7 and 8.

Mast 121 is telescopically and slidingly received in the interior of a tubular main mast 131. The overall height of the two masts 121, 131 is adjusted by sliding upper mast 121 up and down within main mast 131 and locking the two together using a lock ring 133, which is coupled by threads to an upper end of main mast 131 and encircles upper mast 121. Lock ring 133 acts upon a resilient (either elastomeric or formed with a cut-out) compression ring 135, which acts on the exterior of upper mast 121 to secure it against movement within main mast 131. Loosening lock ring 133 permits relative movement and height adjustment, while tightening it secures the two parts against relative movement. Together, main and upper masts 121, 131 form an elevation member that permits the relative height of clamp assembly 113 above a horizontal surface to be adjusted. Rotation of upper mast 121 relative to main mast 131 permits an angular or rotational adjustment, while the hinge of connector 125 permits adjustment of the angle of clamp 113 relative to masts 121, 131.

At the lower end of main mast 131, three legs 137 are connected by hinges to mast 131 in a foldable tripod relationship. A leg lock ring 139 can be moved over the hinge portions of the legs 137 to lock them in the extended or deployed position. A conventional detent temporarily secures lock ring 139 in the locked position. By unlocking leg lock ring 139, it may be moved up mast 131 and legs 137 folded to a stowed position.

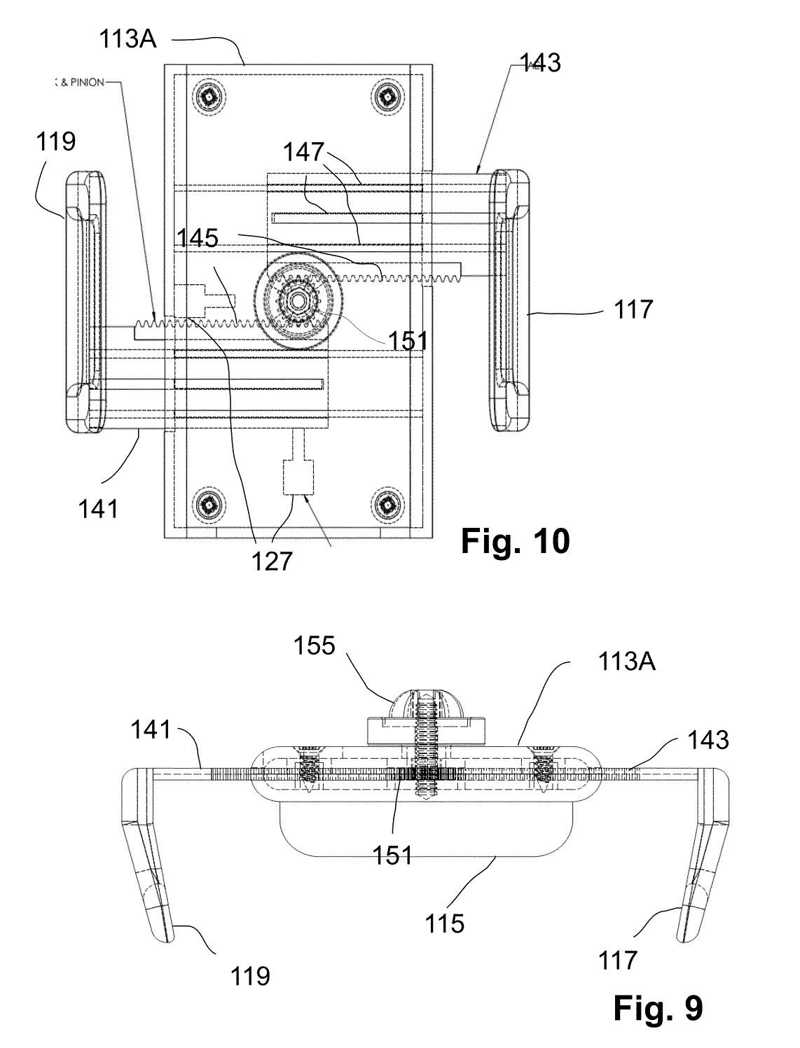

FIGS. 9 and 10 depict the clamp assembly 113 of FIGS. 7 and 8. As shown, each of the movable jaws 117, 119 is carried by an arm 141, 143. Arms 143, 145 are received in a clamp body 113A and each is provided with a gear rack 145. Gear rack 145 on each arm 141, 143 engages a centrally located pinion gear 151 mounted for rotation on the interior of body 113A. Each arm 141, 143 also has three grooves 147 in it that cooperate with corresponding lands in clamp body 113A to maintain orthogonality between arms 141, 143 and clamp body 113A. That is, so that arms 141, 143 remain “square.” The rack and pinion arrangement 145, 151 permits arms 141, 143, and respective jaws 117, 119 mounted thereon, to be moved inwardly and outwardly relative to clamp body 113A by a selected distance. Further, the rack and pinion arrangement insures that jaws 117, 119 extend an equal distance on either side of clamp body 113A, thus “centralizing” about the longitudinal central axis of masts 121, 131, any device held between jaws 117, 119, which can prevent imbalance in the apparatus 111 and reduce tipping. Moreover, having jaws 117, 119 coupled together by rack and pinion permits the distance between the jaws to be adjusted simply by moving one of the pair of jaws 117, 119: the jaws move “in tandem.”

A thumbscrew 155 on the exterior of clamp body 113A engages pinion gear 151. By tightening or loosening thumbscrew 155, gear 151 can be secured by friction against further rotation. In turn jaws 117, 119 are then secured against further movement or loosened for extension (or retraction) to accommodate a device.

The apparatus has a number of advantages. It is adapted to be inexpensively constructed primarily of tubing comprised of a plastic, such as acrylonitrile butadiene styrene (ABS). Such plastic or non-metallic construction makes the stand according to the present invention particularly suited to travel because it will not set off metal detectors at security checkpoints.

The invention has been described with reference to preferred embodiments thereof. It is thus not limited, but is susceptible to variation and modification without departing from the scope and spirit of the invention.

What is claimed is:

1. An apparatus for securing a device in a viewable location, the apparatus comprising:
a mast of selectable length;
a clamp secured to an upper end of the mast in a selectable orientation;
a pair of generally opposing jaws carried by the clamp to engage at least two edges of the device, the jaws being coupled together for extension and retraction;
a plurality of legs extending downwardly from a lower end of the mast, the leg coupled to the mast for selective movement between a folded position and a deployed position; and
a flexible joint between the clamp and mast to permit selective orientation of the clamp and device relative to the mast.

2. The apparatus of claim 1, wherein the legs further comprise:
three legs secured to the mast at their upper ends to form a collapsible tripod; and
a locking ring slidably received over the mast and configured to releasably lock the legs in a deployed position.

3. The apparatus of claim 1, wherein the jaws are coupled together by a rack and pinion arrangement, wherein movement of one jaw causes an equal and opposing movement by the other jaw.

4. The apparatus of claim 1, wherein the mast further comprises:
a generally cylindrical upper mast section telescopically and slidingly received within a tubular lower mast section; and
a lock ring carried between the upper and lower mast sections for selectively securing the upper and lower sections against relative movement.

5. The apparatus of claim 1, further comprising:
a portrait keyhole formed in the clamp, the portrait keyhole cooperating with the flexible joint to maintain the clamp in a portrait orientation.

6. The apparatus of claim 1, further comprising:
a landscape keyhole formed in the clamp, the landscape keyhole cooperating with the flexible joint to maintain the clamp in a landscape orientation.
